(19) United States
(12) Patent Application Publication
(10) Pub. No.: US 2005/0017075 A1
(43) Pub. Date: Jan. 27, 2005

(54) IMAGE-PROCESSING APPARATUS HAVING A LOCK BUTTON

(76) Inventors: Mei-Tai Chou, Taipei City (TW); Wei-Che Shen, Taipei City (TW); Yu-Ju Tung, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/710,386

(22) Filed: Jul. 6, 2004

(30) Foreign Application Priority Data
Jul. 14, 2003 (TW) 092119173

(51) Int. Cl. G06K 7/14; G06K 7/10

(52) U.S. Cl. 235/454

(57) ABSTRACT

An image-processing apparatus includes a plurality of function buttons for controlling the operation of the image-processing apparatus, a lock button for enabling and disabling the plurality of function buttons, and a display device for displaying the condition of the image-processing apparatus and the plurality of function buttons.

### BACKGROUND OF INVENTION

1. Field of the Invention

The present invention relates to an image-processing apparatus, and more specifically, to an image-processing apparatus having a lock button to enable or disable a keyboard.

2. Description of the Prior Art

Present image-processing apparatuses, such as scanners, printers, facsimiles, copy machines, and multifunction products (MFP), are able to copy images. As computer technology progresses, most of the image-processing apparatuses can be connected to a computer to be a peripheral for image processing by the computer. However, these image-processing apparatuses can also operate independently for users to edit images without a connection with the computer. For instance, some printers can directly read the image data in a memory card and print them into photographs. Quality, size, and number of the photographs can be set up with the printer. Of course, a plurality of function buttons, lights, and a display panel are installed on the printer for providing options. These settings are stored in a memory of the printer to inform users of conditions and settings of the printer through the lights and the display panel.

A typical image-processing apparatus is large and provides a space near the function buttons for a user to place stationery or folders. Therefore, it is possible to press the function buttons inadvertently so that the settings are changed or even the image-processing apparatus is turned on. When a user incorrectly presses a copy button of an MFP, the MFP may start scanning or printing. Although these operations can be cancelled, unnecessary waste of paper and ink cannot be recovered. In order to solve this problem, a cover can be installed above the function buttons, however, the cover is not necessarily convenient or good-looking, and definitely causes additional cost.

As mentioned above, image-processing apparatuses are widely used in many applications including personal and home use, in companies, and in offices. However, whether used independently or in connection to a computer, the problem of incorrectly pressing the buttons is inevitable. Moreover, when the image-processing apparatus is shared commonly amongst several users, a authority of use should be limited to prevent waste and damage due to incorrect operation.

### SUMMARY OF INVENTION

It is therefore a primary objective of the present invention to provide an image-processing apparatus having a lock button to enable or disable a keyboard to solve the problems mentioned above.

Briefly summarized, an image-processing apparatus includes a plurality of function buttons for controlling the operation of the image-processing apparatus, a lock button for enabling and disabling the plurality of function buttons, and a display device for displaying the condition of the image-processing apparatus and the plurality of function buttons. The image-processing apparatus further includes a timer for calculating a first time and a second time. The image-processing apparatus can disable the plurality of function buttons after the first time under the condition of the plurality of function buttons being originally enabled, and can enable the plurality of function buttons after the second time period under the condition of the plurality of function buttons being originally disabled. The image-processing apparatus further includes a password protection device for setting up a password for the lock button to enable and disable the plurality of function buttons, so that the password is required when the lock button enables and disables the plurality of function buttons.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates an external view of an MFP according to the present invention.

FIG. 2 illustrates a block diagram of the MFP.

FIG. 3 is a flowchart of setting up the timer and the password protection device in FIG. 2.

FIG. 4 is a flowchart of setting up the lock button.

### DETAILED DESCRIPTION

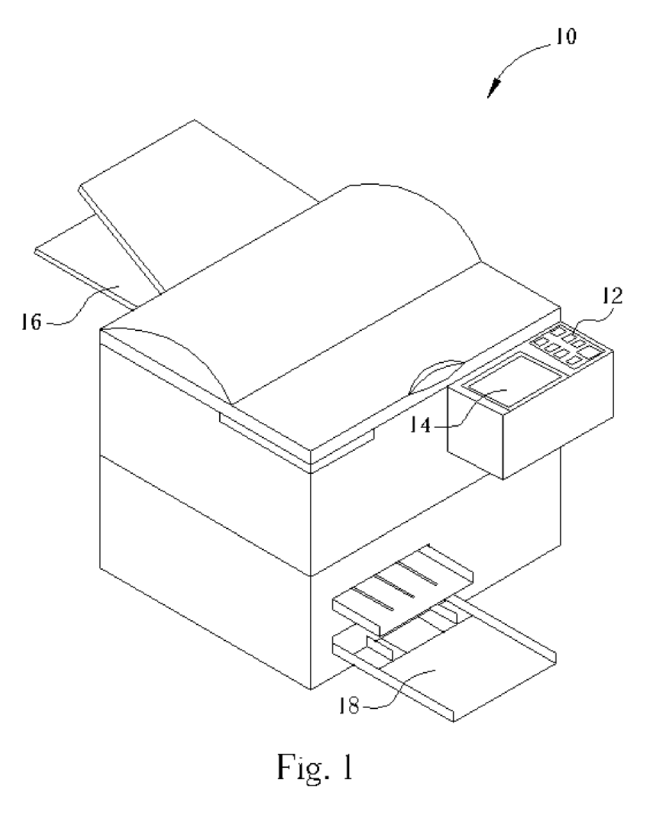

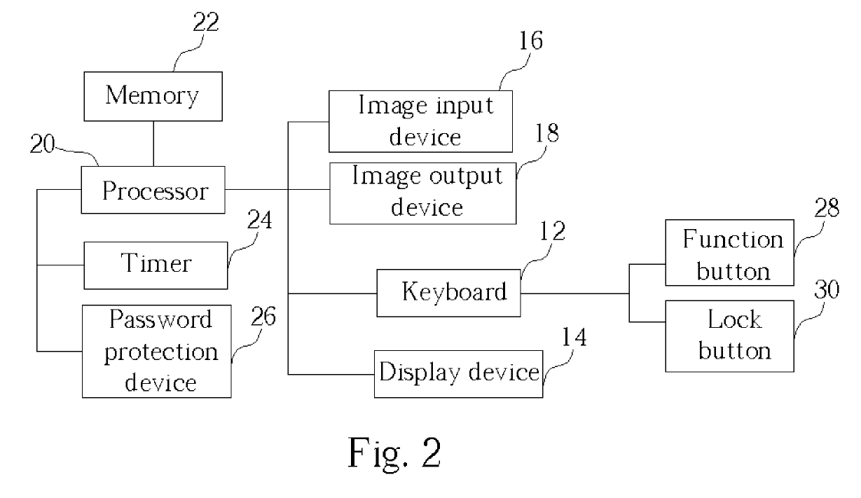

Please refer to FIG. 1 showing an external view of an MFP 10 according to the present invention, and FIG. 2 showing a block diagram of the MFP 10. Image-processing apparatuses include scanners, printers, facsimiles, copy machines, and MFPs. The MFP 10 is hereby taken as an example in a preferred embodiment of the present invention. As shown in FIG. 1, the MFP 10 externally includes a keyboard 12, a display device 14, an image input device 16, and an image output device 18. As shown in FIG. 2, the MFP 10 internally includes a processor 20, a memory 22, a timer 24, and a password protection device 26. The processor 20 is for controlling the operation of the MFP 10 and for displaying the condition of the MFP 10 through lights on the display device 14. A user can operate the MFP 10 with the keyboard 12 according to the instructions by the display device 14. The image input device 16 is for copying image data to be processed, and the image output device 18 is for printing processed image data. The keyboard 12 includes a plurality of function buttons 28 and a lock button 30. The plurality of function buttons 28 is for enabling scanning, printing, facsimileing, and copying with the MFP 10 and for setting the quality, size, and number of outputs.

The lock button 30 is for enabling and disabling the plurality of function buttons 28. When the plurality of function buttons 28 is enabled, pressing the lock button 30 can disable the plurality of function buttons 28. Under this condition, no reaction happens, or messages of reconfirmation are displayed by the display device 14 when one or more of the plurality of function buttons 28 is pressed. For instance, when a disabled copy button is pressed, the display device 14 will show a message such as “Copy?”. Of course, any message telling the user that the button is disabled is allowed, including saying “Button is disabled”. But this example tells the user to press another confirm key to unlock the disabled button, not only tell him or her that the key he pressed been disabled. When the user presses a confirm button, the keyboard 12 is enabled and the MFP 10 starts operation. In such a manner, the function buttons will not be pressed incorrectly. When the plurality of function buttons 28 is disabled, the user can press the lock button 30 to enable the plurality of function buttons 28.

The timer 24 provides automatic enabling and disabling of the plurality of function buttons 28 of the MFP 10. A first time and a second time can be set by the user. When the timer 24 operates, after the MFP 10 enters an idle mode, the processor 20 detects the condition of the plurality of function buttons 28. If the plurality of function buttons 28 is enabled, the plurality of function buttons 28 will be disabled automatically after the first time. If the plurality of function buttons 28 is disabled, the plurality of function buttons 28 will be enabled automatically after the second time.

The password protection device 26 provides a password protection for enabling and disabling the plurality of function buttons 28. The user can set up a password and the processor 20 will store it into the memory 22. When password protection is enabled, when the user presses the lock button 30 to enable or disable the plurality of function buttons 28, the password is required. If the copy button is pressed, the password is required after the confirmation message. Therefore, when the password protection is turned on, the user needs the password to operate the MFP 10. In addition, the MFP 10 can be connected to a computer (not shown) or operate independently. When the MFP 10 is connected to the computer, even if the plurality of function buttons 28 is disabled, the MFP 10 can still receive and execute commands from the computer.

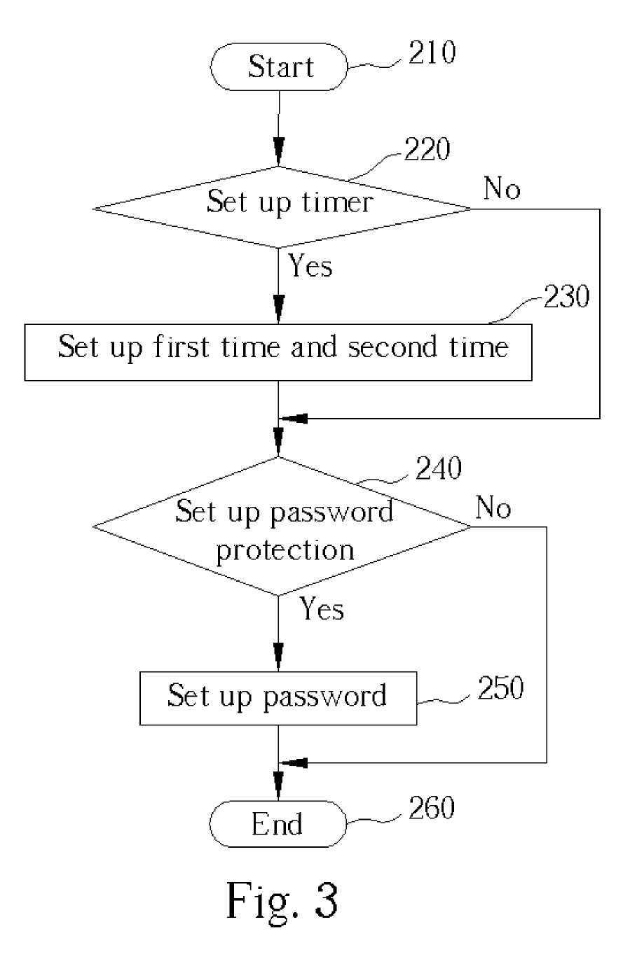

Please refer to FIG. 3 showing a flowchart of setting up the timer 24 and the password protection device 26 in FIG. 2. The timer 24 provides a method for the MFP 10 to enable and disable the plurality of function buttons 28 automatically, so that the plurality of function buttons 28 can be automatically enabled or disabled when the MFP 10 enters in idle mode after a predetermined time. The password protection device 26 provides a password protection for enabling and disabling the plurality of function buttons 28, so that a password is required when the user presses the lock button 30 to enable and disable the plurality of function buttons 28, in order to limit the authority of use of the MFP 10. The setup of the timer 24 and the password protection device 26 is as follows:

Step 210: Enter a setup mode of the MFP 10. Start to set up the timer and the password protection.

Step 220: Set up the timer? If yes, proceed to Step 230, if no, proceed to Step 240.

Step 230: Determine the first time and the second time. When the MFP 10 enters an idle mode, the MFP 10 will disable the plurality of function buttons 28 automatically after the first time. If the first time is zero, the MFP 10 will not disable the plurality of function buttons 28 automatically. The plurality of function buttons 28, if disabled, will be enabled automatically after the second time. If the second time is zero, the MFP 10 will not enable the plurality of function buttons 28 automatically.

Step 240: Set up the password protection? If yes, proceed to Step 250, if no, proceed to Step 260.

Step 250: Set up the password. The user can set up one or several passwords. If one password is set up, the user can select whether to require the password only when enabling or disabling the plurality of function buttons 28. If several password are set up, different passwords may be required when enabling or disabling the plurality of function buttons 28.

Step 260: Finish setup of the timer and the password protection. End setup mode of the MFP 10.

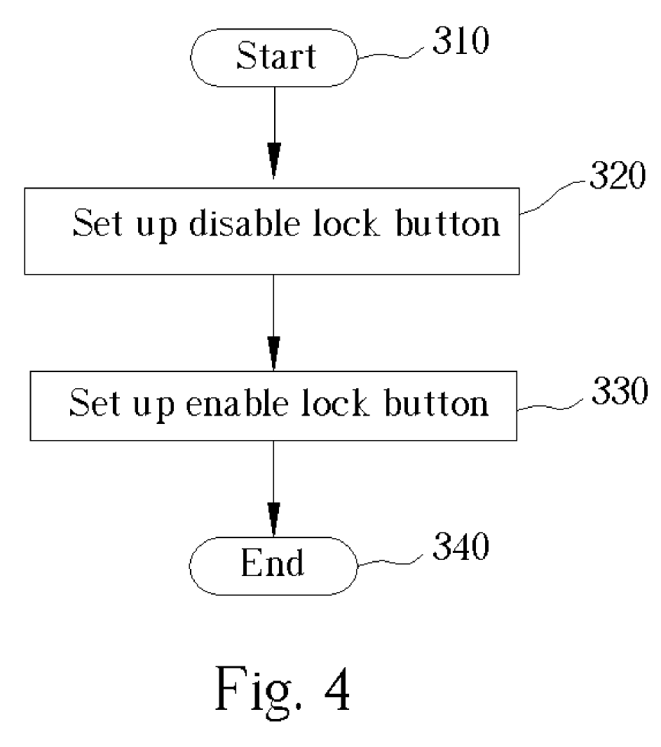

Please refer to FIG. 4 showing a flowchart of setting up the lock button. In another embodiment of the present invention, a method for users to set up the lock button manually is provided, which is as follows:

Step 310: Enter setup mode of the MFP 10. Start to set up the lock button.

Step 320: Set up disable lock button. The user can manually set up a disable lock button on the keyboard 12 of the MFP 10. The lock button to be set up can be any button or combination of buttons on the keyboard 12 but not a start button such as the copy button or a scan button. If the user sets up a number key sequence 0, 1, 2, 3 for the disable lock button, after setup, when the user presses number keys 0, 1, 2, 3 serially, the MFP 10 will disable all the buttons in the keyboard 12.

Step 330: Set up enable lock button. The user can set up an enable lock button to be the same as the disable lock button, or different from the disable lock button, such as number keys 4, 5.

Step 340: Finish setup of the lock button. End setup mode of the MFP 10.

As mentioned above, the image-processing device provides the plurality of buttons for operation. In the embodiments of the present invention, the MFP 10 taken as an example, the lock button 30 and the method for setting up the lock button is provided to enable and disable the buttons of the keyboard 12 in order to prevent incorrect operation which causes unnecessary waste. In addition, the timer 24 also provides a device and method for enabling and disabling the keyboard 12 of the MFP 10 automatically, so that it is more convenient to lock the keyboard. The password protection device 26 provides the user with a method to manage the authority of the MFP 10 to ensure the security of the keyboard.

In contrast to the prior art, the present invention provides an image-processing apparatus having a lock button for enabling and disabling the keyboard. The image-processing apparatus further includes a timer and a password protection device for enabling and disabling the keyboard automatically and password protection. Compared with the prior art, the present invention is more convenient, safer, and more reliable.

Those skilled in the art will readily observe that numerous modifications and alterations of the device may be made while retaining the teachings of the invention. Accordingly, the above disclosure should be construed as limited only by the metes and bounds of the appended claims

1. An image-processing apparatus comprising:
a plurality of function buttons for controlling the operation of the image-processing apparatus;
a lock button for enabling and disabling the plurality of function buttons; and
a display device for displaying the condition of the image-processing apparatus and the plurality of function buttons.

2. The image-processing apparatus of claim 1 further comprising a timer for calculating a first time for the image-processing apparatus to disable the plurality of function buttons after the first time, under the condition of the plurality of function buttons being originally enabled.

3. The image-processing apparatus of claim 2 wherein the timer further calculates a second time for the image-processing apparatus to enable the plurality of function buttons after the second time, under the condition of the plurality of function buttons being originally disabled.

4. The image-processing apparatus of claim 1 further comprising a password protection device for setting up a password for the lock button to enable and disable the plurality of function buttons, so that the password is required when the lock button enables and disables the plurality of function buttons.

5. The image-processing apparatus of claim 1 wherein the image-processing apparatus is connected to a computer, and the image-processing apparatus can receive and execute commands from the computer.

6. The image-processing apparatus of claim 1 wherein the plurality of function buttons includes a copy button for enabling the image-processing apparatus to copy documents.

7. The image-processing apparatus of claim 6 wherein when the copy button is pressed when the copy button is disabled, the display device displays an unlock message.

8. The image-processing apparatus of claim 1 wherein the display device is a light emitting diode (LED) or a liquid crystal display (LCD).

9. The image-processing apparatus of claim 1 being a multifunction product (MFP).

10. The image-processing apparatus of claim 1 being a printer.

11. The image-processing apparatus of claim 1 being a scanner.
